(19) United States
(12) Patent Application Publication
(10) Pub. No.: US 2014/0025966 A1
(43) Pub. Date: Jan. 23, 2014

(54) INFORMATION PROCESSING SYSTEM, SYSTEM MANAGEMENT APPARATUS, AND INTEGRATED CIRCUIT

(71) Applicant: FUJITSU LIMITED, Kawasaki-shi (JP)

(72) Inventors: Yoshikazu IWAMI, Inagi (JP); Akira OKAMOTO, Kawasaki (JP)

(73) Assignee: FUJITSU LIMITED, Kawasaki-shi (JP)

(21) Appl. No.: 14/035,480

(22) Filed: Sep. 24, 2013

Related U.S. Application Data
(63) Continuation of application No. PCT/JP2011/058363, filed on Mar. 31, 2011.

(51) Int. Cl. G06F 1/26

(52) U.S. Cl. CPC G06F 1/26
USPC 713/300

(57) ABSTRACT

An information processing system including: a plurality of information processing apparatuses including a system board provided with an integrated circuit and a power-supply circuit that supplies electricity to the integrated circuit; and a system management apparatus that transmits a power-on instruction to the plurality of information processing apparatuses, wherein the integrated circuits of the plurality of information processing apparatuses each include a plurality of power-supply domains, and, upon receipt of the power-on instruction, the integrated circuits instruct the power-supply circuit to adjust a voltage and supply electricity sequentially to the plurality of power-supply domains.

### CROSS-REFERENCE TO RELATED APPLICATION

This application is a continuation of PCT application of PCT/JP2011/058363 filed on Mar. 31, 2011 and designated the U.S., the entire contents of which are incorporated herein by reference.

### FIELD

The embodiments discussed herein are related to an information processing system, a system management apparatus, and an integrated circuit which execute a power-on sequence.

### BACKGROUND

A large-scale server system that includes many servers is provided with a system management apparatus that includes a management board (MMB), and the MMB manages the entire system.

The managing of a system herein means, for example, setting up a power supply or a clock, resetting the system, and setting up registers for various operations. Using an external interface, the MMB controls a large scale integration (LSI) circuit and a VR (DC-DC converter) provided at each server.

During system activation, for the LSI circuit and the power-supply circuit of each server, the MMB sets up a power supply or a clock, resets the system, and sets up registers for various operations.

In recent years, the scale of server systems has been enlarged, and objects controlled by MMBs, such as servers and LSI circuits, have increased. Thus, due to an increase in the number of objects to be set up by an MMB during system activation, there has been a problem wherein a longer time is required to activate the system.

Patent document 1: Japanese Laid-open Patent Publication No. 2006-187152
Patent document 2: Japanese Laid-open Patent Publication No. 2008-206223

### SUMMARY

According to an aspect of the invention, an information processing system includes: a plurality of information processing apparatuses that include a system board provided with an integrated circuit and a power-supply circuit that supplies electricity to the integrated circuit; and a system management apparatus that transmits a power-on instruction to the plurality of information processing apparatuses.

The integrated circuits of the plurality of information processing apparatuses each include a plurality of power-supply domains, and, upon receipt of the power-on instruction, the integrated circuits instruct the power-supply circuit to adjust a voltage and supply electricity sequentially to the plurality of power-supply domains.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B illustrate a configuration diagram of a system in accordance with an embodiment.

FIGS. 2A to 2D illustrate a power-on sequence of a system in accordance with an embodiment.

FIG. 3 illustrates a configuration diagram of details of a power-supply circuit and an LSI circuit in accordance with an embodiment.

FIGS. 4A and 4B illustrate a power-on sequence of an LSI circuit in accordance with an embodiment.

FIGS. 4C and 4D illustrate a power-on sequence of an LSI circuit in accordance with an embodiment.

FIG. 5 is a flowchart of details of a temporary stop process.

FIG. 6 illustrates a configuration related to register settings of an LSI circuit in accordance with an embodiment.

FIG. 7A illustrates data writing to a register in accordance with an embodiment.

FIG. 7B illustrates data writing to a register in accordance with an embodiment.

FIG. 8 illustrates a configuration related to adjustment of a power-supply circuit of an LSI circuit in accordance with an embodiment.

FIG. 9 is a flowchart of a process performed by a power-supply adjustment sequencer in accordance with an embodiment.

FIG. 10 is a configuration diagram of a system in accordance with another embodiment.

FIGS. 11A to 11C illustrate a power-on sequence of a system in accordance with another embodiment.

### DESCRIPTION OF EMBODIMENT

In the following, embodiments will be described with reference to the drawings.

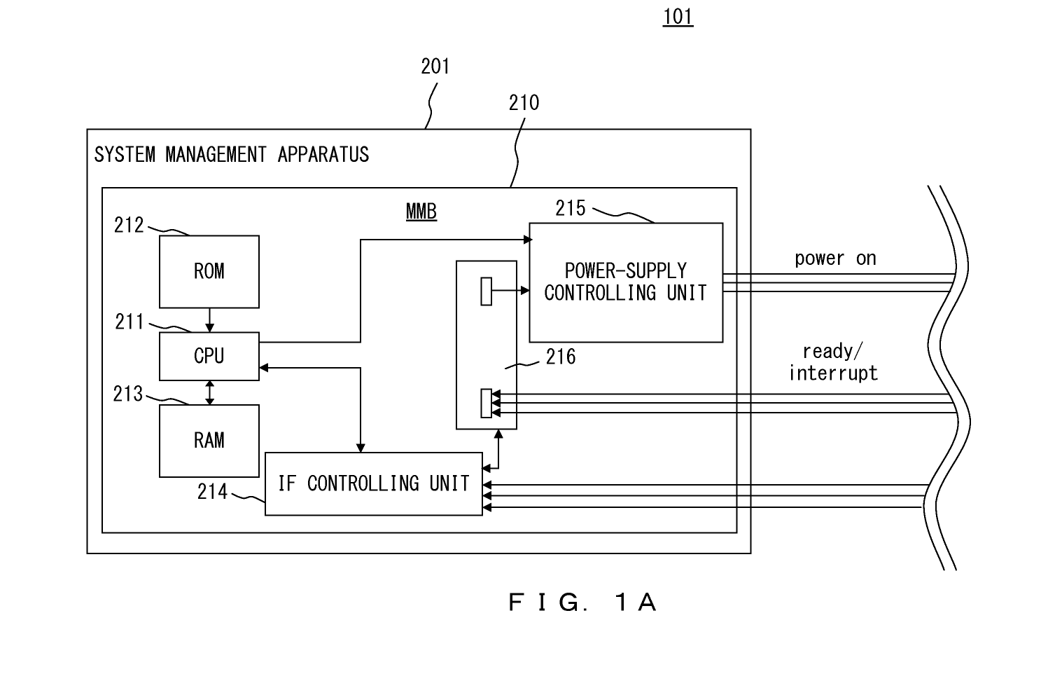

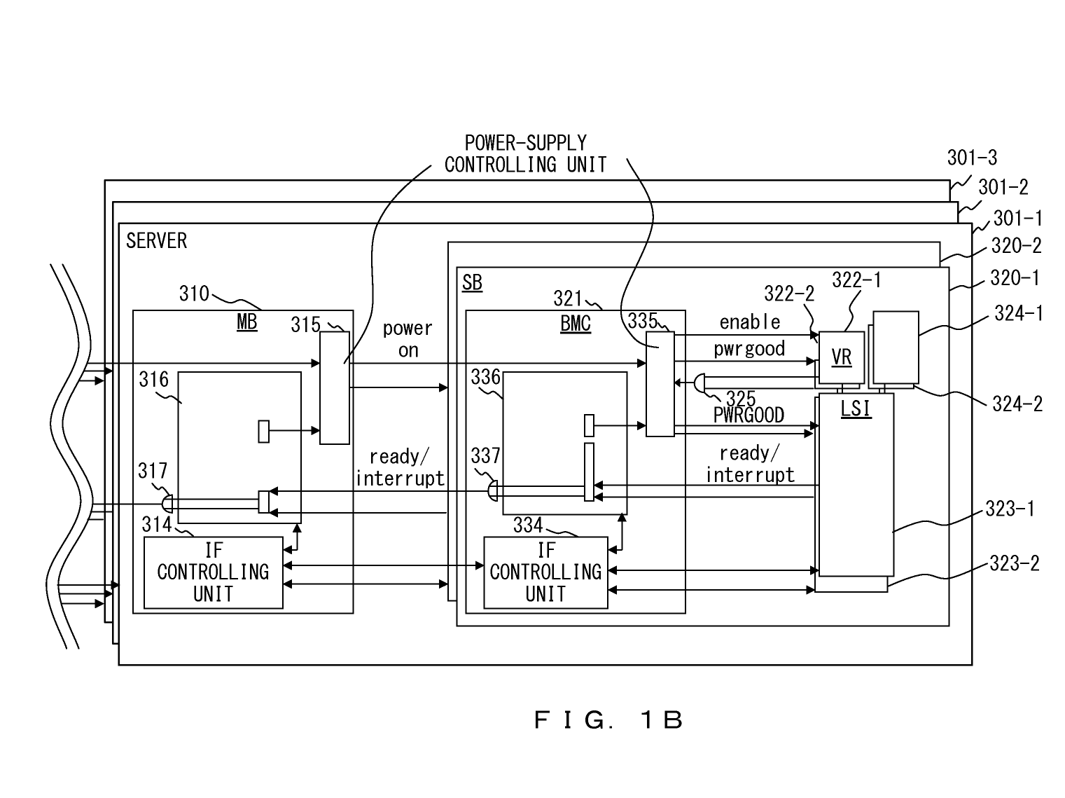

FIGS. 1A and 1B illustrate a configuration diagram of a system in accordance with an embodiment.

A system 101 includes a system management apparatus 201 and servers 301-i (i=1 to 3).

The servers 301-1 to 301-3 have the same configuration, so only a configuration of the server 301-1 will be described in detail with reference to the embodiment. In addition, only the detailed configuration of the server 301-1 is depicted in FIGS. 1A and 1B.

The system management apparatus 201 and the server 301 are connected via a serial interface (e.g., an inter-integrated circuit (I2C)).

The system management apparatus 201 includes a management board (MMB) 210.

The MMB 210 gives a power-on instruction to the servers 301 and identifies the server 301 that has failed in power-on.

The MMB 210 includes a central processing unit (CPU) 211, a read only memory (ROM) 212, a random access memory (RAM) 213, an interface (IF) controlling unit 214, a power-supply controlling unit 215, and a storage unit 216.

The CPU 211 reads and executes a program stored in the ROM 212.

The ROM 212 is storage means that stores a program for performing various processes described hereinafter.

The RAM 213 is storage means that temporarily stores data used in various processes.

The IF controlling unit 214 controls an interface between the MMB 210 and a server 320. The IF 214 also writes data to and reads data from the storage unit 216.

According to a content of the storage unit 216 and an instruction from the CPU 211, the power-supply controlling unit 215 outputs a power-on instruction to the server 301 to be turned on.

The storage unit 216 stores, for example, information indicating a server to be powered on, information indicating the completion of powering-on of a server, and information indicating interruption. The storage unit 216 is, for example, a register. Upon receipt of a Ready response or an interruption response from the server 301, the storage unit 216 stores, for example, information indicating the completion of powering-on of a server 320 or information indicating interruption.

The server 301-1 includes a management board (MB) 310 and system boards (SBs) 320-j (j=1, 2).

Since the SBs 320-1 and 320-2 have the same configuration, only the configuration of the SB 320-1 will be described in detail with reference to the embodiment. Note that only the configuration of the SB 320-1 is depicted in detail in FIGS. 1A and 1B.

The MB 310 includes an IF controlling unit 314, a power-supply controlling unit 315, a storage unit 316, and a signal outputting circuit 317.

The IF controlling unit 314 controls interfaces between the MB 310 and the MMB 210 and between the MB 310 and the SB 320. The IF controlling unit 314 reads data from and writes data to the storage unit 316.

According to a content of the storage unit 316 (e.g., information indicating an SB 320 or an LSI circuit 323 to be turned on) and an instruction from the power-supply controlling unit 215, the power-supply controlling unit 315 outputs a power-on instruction to an SB 320 to be turned on.

The storage unit 316 stores, for example, information indicating the SB 320 to be powered on from the MMB 210, information indicating the completion of powering-on of the SB 320 from the SB 320, and information indicating interruption. The storage unit 316 is, for example, a register. Upon receipt of a Ready response from an SB 320, the storage unit 316 stores information indicating the completion of powering-on of the SB 320 that has transmitted the Ready response; upon receipt of an interruption response, the storage unit 316 stores, for example, information indicating interruption by the SB 320 that has transmitted the interruption response.

The signal outputting circuit 317 includes an AND circuit and an OR circuit and outputs a Ready response or an interruption response. In particular, when information indicating a power-on completion from all of the SBs 320 within the server 301-1 is stored in the storage unit 316, the AND circuit outputs a Ready response to the MMB 210. When information indicating interruption by any of the SBs 320 within the server 301-1 is stored in the storage unit 316, the OR circuit outputs an interruption response to the MMB 210.

The SB 320-1 includes a board management controller (BMC) 321, power-supply circuits (VRs) 322-j (j=1, 2), LSI circuits 323-j, DIMMs 324-j, and an AND circuit 325.

The BMC 321 includes an IF controlling unit 334, a power-supply controlling unit 335, a storage unit 336, and a signal outputting circuit 337.

The IF controlling unit 334 controls an interface between the SB 320 and the MB 310. The IF controlling unit 334 also writes data to and reads data from the storage unit 336.

According to a content of the storage unit 336 and an instruction from the power-supply controlling unit 315, the power-supply controlling unit 335 outputs a power supply instruction (an enable signal) to a target power-supply circuit 322. The power-supply controlling unit 335 also outputs a PWRGOOD signal indicating a preparation completion to the LSI circuit 323.

The storage unit 336 stores, for example, information indicating the power-supply circuit 322 and the LSI circuit 323 to be powered on from the MB 310, information indicating the completion of powering-on of the LSI circuit 320, and information indicating interruption. The storage unit 336 is, for example, a register. Upon receipt of a Ready response from an LSI circuit 323, the storage unit 336 stores information indicating the completion of powering-on of the LSI circuit 323 that has transmitted the Ready response; upon receipt of an interruption response, the storage unit 316 stores, for example, information indicating interruption of the LSI circuit 323 that has transmitted the interruption response.

The signal outputting circuit 337 includes an AND circuit and an OR circuit and outputs a Ready response or an interruption response. In particular, when information indicating a power-on completion from all of the LSI circuits 323 within the SB 320-1 is stored in the storage unit 336, the AND circuit outputs a Ready response to the MB 310. When information indicating interruption by any of the LSI circuits 323 within the SB 320-1 is stored in the storage unit 336, the OR circuit outputs an interruption response to the MB 310.

The power-supply circuit 322-j supplies electricity to the LSI circuit 323-j and the DIMM 324-j. In accordance with an input voltage parameter, the power-supply circuit 322-j supplies to the LSI circuit 323-j and the DIMM 324-j voltages that have been set for the LSI circuit 323-j and the DIMM 324-j, respectively. The power-supply circuit 322-j is, for example, a DC-DC converter.

The LSI circuit 323-j is a processing unit that performs various processes. The LSI circuit 323-j is, for example, a CPU or a memory control unit (MCU). The LSI circuit 323-j is connected to the power-supply circuit 322-j and the DIMM 324-j.

The DIMM 324-j is storage means that stores data used by the LSI circuit 323-j.

Upon receipt of a pwrgood signal indicating a power-supply preparation completion from all of the power-supply circuits 322 (i.e., the power-supply circuits 322-1 and 322-2) on the same SB, the AND circuit 325 outputs the pwrgood signal to the power-supply controlling unit 335.

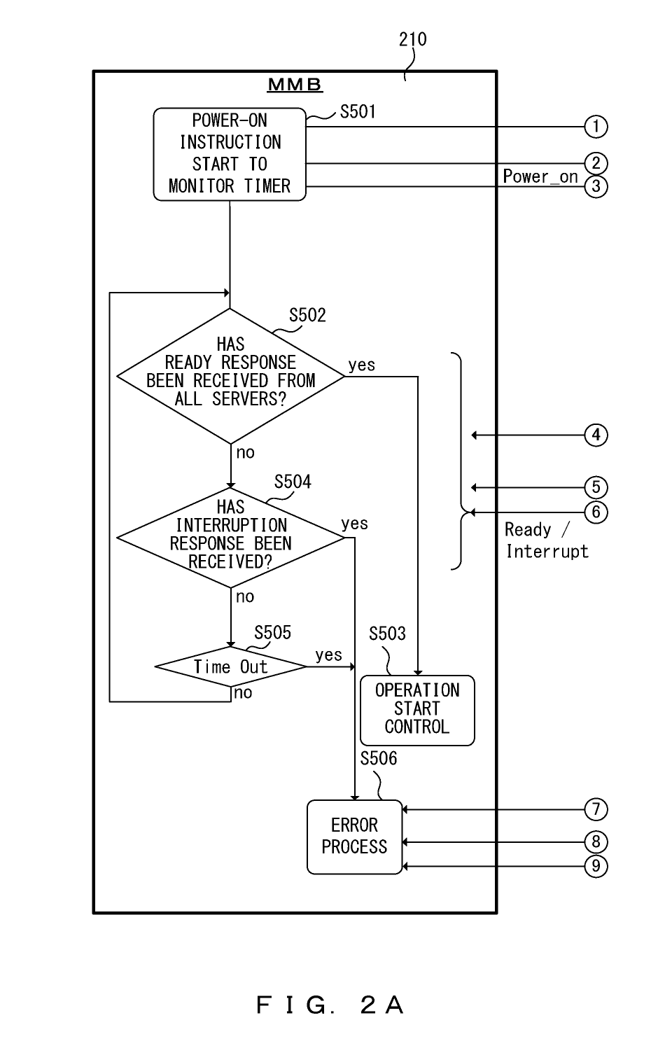

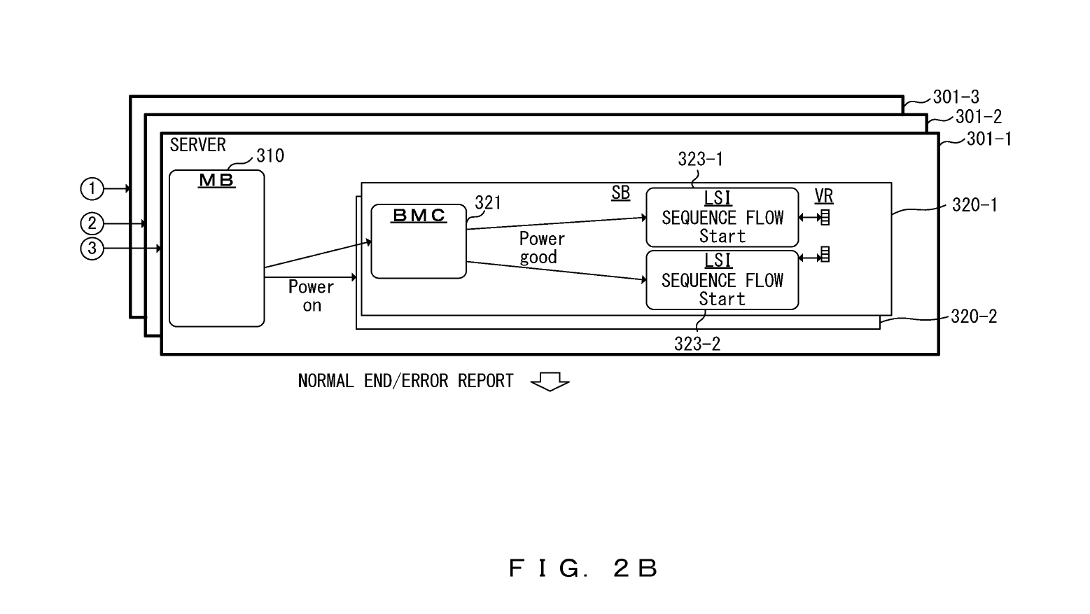

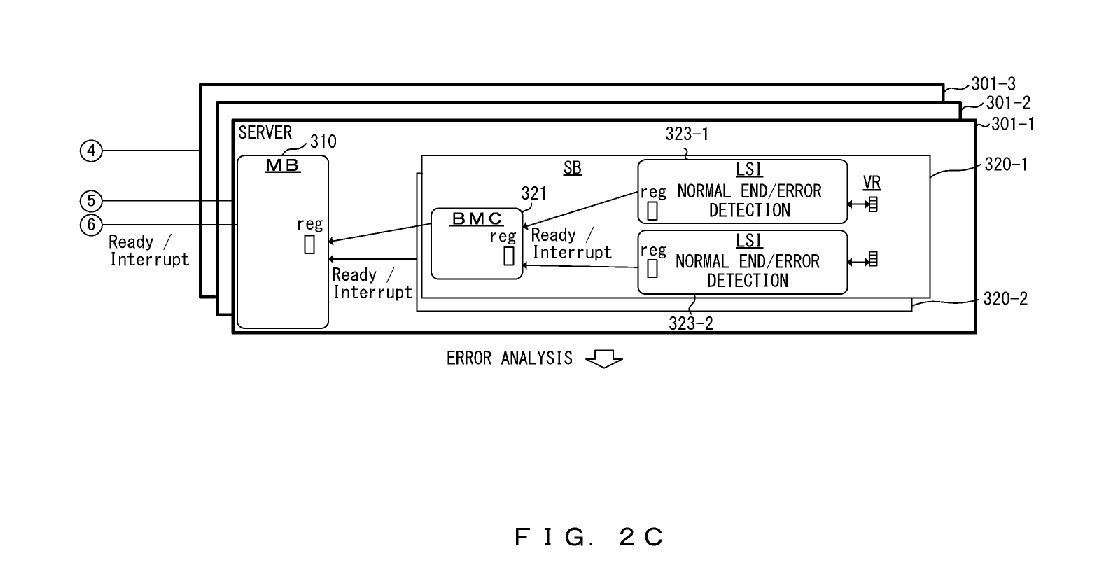

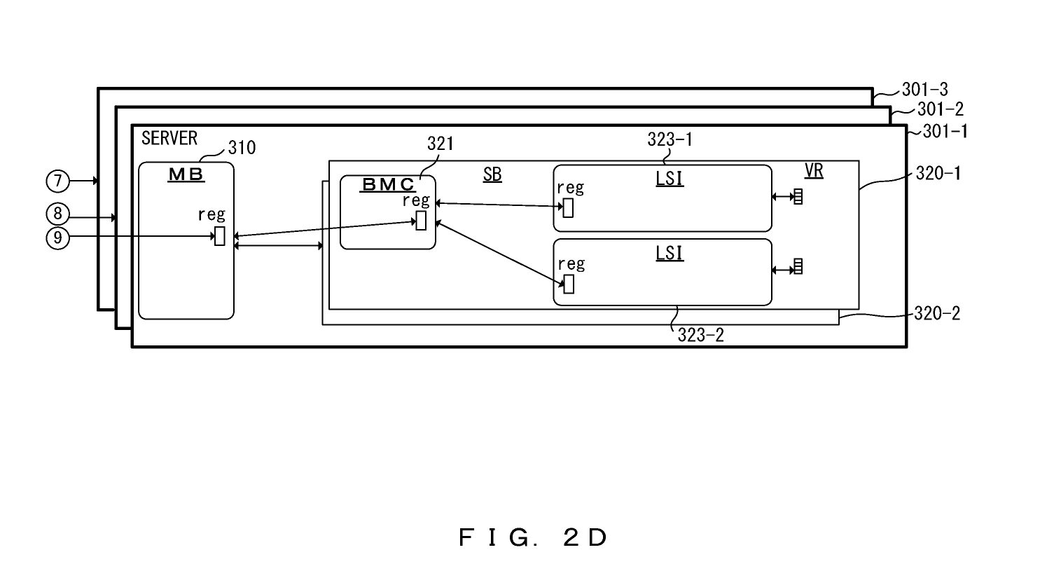

FIGS. 2A to 2D illustrate a power-on sequence of a system in accordance with an embodiment.

In step S501, the MMB 210 transmits a power-on instruction to the MB 310 provided on each server 303. Then, the MMB 210 activates a timer and starts to monitor the timer.

The MB 310 of each server 303 which has received the power-on instruction transmits the power-on instruction to the BMC 321 provided at the SB 320 within the same server, and manages a Ready response from the BMC 321.

Upon receipt of the power-on instruction from the MB, the BMC 321 turns on a power-supply switch within the SB 320, and waits for the power-supply circuit 322 that supplies electricity to each LSI circuit 323 to be stabilized. After the power-supply circuit 322 is stabilized, the BMC 321 outputs to each LSI circuit 323 a PWRGOOD signal indicating a power-supply preparation completion. Upon receipt of the PWRGOOD signal, the LSI circuit 323 executes a predetermined power-on sequence. When the power-on sequence is completed, the LSI circuit 323 outputs a Ready response to the BMC; when the power-on sequence is not completed even after a predetermined time period has elapsed, the LSI circuit 323 outputs an interruption response to the BMC.

The BMC 321 outputs a Ready response to the MB 310 when the BMC 321 receives a Ready response from all of the LSI circuits 323 within the same server; the BMC 321 outputs an interruption response to the MB 310 when the BMC 321 receives an interruption response from any of the LSI circuits 323 within the same server.

The MB 310 outputs a Ready response to the MMB 210 when the MB 310 receives a Ready response from all of the SBs 320 within the same server; the MB 310 outputs an interruption response to the MMB 210 when the MB 310 receives an interruption response from any of the SBs 320 within the same server.

In step S502, the MMB 210 checks whether or not a Ready response has been received from all of the servers 301; the control shifts to step S503 when a Ready response has been received from all of the servers 301, and the control shifts to step S504 when any of the servers 301 has not transmitted a Ready response. The Ready response indicates that the activation of the server has been completed, i.e., that the preparation of, for example, the power supply of the server, the setting of a clock, and the register for settings has been completed.

In step S503, in response to the completion of the preparation of all of the servers 301, the MMB 210 starts to operate the system 101.

In step S504, the MB 201 checks whether or not an interruption response has been received from a server 301; the control shifts to step S506 when an interruption response has been received, and the control shifts to step S505 when an interruption response has not been received from any of the servers.

In step S505, the MMB 210 determines whether or not the timer activated in step S502 has expired. When the timer has not expired (i.e., before time out), the control returns to step S502; when the timer has expired (i.e., after time out), the control shifts to step S506.

In step S506, the MMB 210 performs an error process.

The error process will be described with reference to a situation in which a judgment of YES is indicated in step S504 and to a situation in which a judgment of YES is indicated in step S505.

When a judgment of YES is indicated in step S504, then in the error process, the MMB 210 sends a query to the MB 310 of the server 301 for which an interruption response is ON, and recognizes the SB 320 for which the interruption response is ON. Next, the MMB 210 sends a query to the BMC 321 within the SB 320 for which the interruption response is ON, and recognizes the LSI circuit 323 for which the interruption response is ON.

When a judgment of YES is indicated in step S505, then in the error process, the MMB 210 sends a query to the MB 310 of the server 301 for which a Ready response is OFF, and recognizes the SB 320 for which the Ready response is OFF. Next, the MMB 210 sends a query to the BMC 321 within the SB 320 for which the Ready response is OFF, and recognizes the LSI circuit 323 for which the Ready response is OFF.

As described above, gaining only two accesses to the server from the MMB 210 in the error process allows a portion corresponding to a failure of a power-on sequence to be specified.

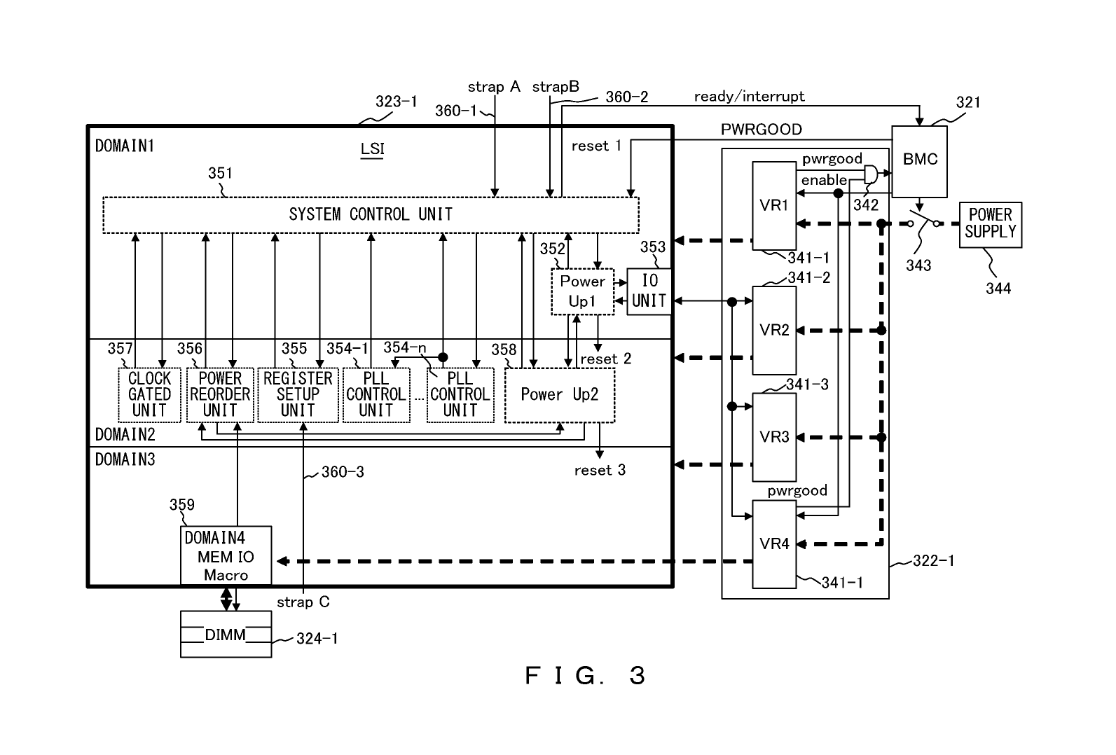

FIG. 3 illustrates a configuration diagram of details of a power-supply circuit and an LSI circuit in accordance with an embodiment.

In FIG. 2A to 2D, the power-supply circuit 322-1 has the same configuration as the power-supply circuit 322-2, the LSI circuit 323-1 has the same configuration as the LSI circuit 323-2, and the DIMM 324-1 has the same configuration as the DIMM 324-2. Thus, only the power-supply circuit 322-1, the LSI circuit 323-1, and the DIMM 324-1 will be described with reference to FIG. 3, and the descriptions of the power-supply circuit 322-2, the LSI circuit 323-2, and the DIMM 324-2 will be omitted.

The BMC 321 turns on a switch 343 so as to cause a power supply 344 provided at the server 301-1 to supply electricity to the power-supply circuit 322-1.

Upon receipt of a power-on instruction from the MMB 201 via the MB 321, the BMC 321 turns on the switch 343 so as to cause the power supply 344 to supply electricity to power-supply conversion elements 341-1 to 341-4. The BMC 321 also outputs an enable signal that serves as a power-supply feeding instruction to the power-supply conversion elements 344-1 and 341-4. Moreover, the BMC 321 outputs, to a domain 1 of the LSI circuit 321-1, a reset signal (reset1) that initializes an element within the domain 1.

Upon receipt of a PWRGOOD signal indicating a preparation completion from an AND circuit 342, the BMC 321 outputs the PWRGOOD signal to a system control unit 351. In this case, the BMC 321 puts the reset signal (reset1) in an OFF state.

The power-supply circuit 322-1 includes voltage conversion elements 341-k (k=1 to 4) and the AND circuit 342. The voltage conversion elements 341-1 to 341-4 may be respectively referred to as VRs1 to 4 or power supplies 1 to 4.

The voltage conversion elements 341-1 to 341-4, which are associated with any of domains 1 to 4 of the LSI circuit 323-1, convert a voltage input by the power supply 344 and supply the converted voltage to an associated domain of the domains 1 to 4. The voltage conversion element 341-4 also supplies electricity to the DIMM 324-1. The voltage conversion elements 341-2 to 341-4 each include a register (not illustrated) therein and hold the value of a currently output voltage in the register. The power-supply conversion elements 341-1 and 341-4, which have received the enable signal, each output a PWRGOOD signal indicating a preparation completion to the AND circuit 342 when it becomes possible for the voltage conversion element to supply electricity with an initial voltage (e.g., 1.5V) to the LSI circuit 313-1 (i.e., when the power supply is stabilized).

The power-supply conversion elements 341-1 and 341-2 each supply electricity with an initial voltage. The initial setting voltage of the power-supply conversion elements 341-2 and 341-3 is OV, i.e., electricity is not supplied from the power-supply conversion elements 341-2 and 341-3 to the LSI circuit 313-1.

The AND circuit 342 outputs to the BMC 321 a logical product of PWRGOOD signals from the voltage conversion elements 341-1 and 341-4. That is, when PWRGOOD signals are output from the voltage conversion elements 341-1 and 341-4, the AND circuit 342 outputs a PWRGOOD signal to the BMC 321.

The LSI circuit 323-1 is provided with sequencers, which will be described hereinafter, and these sequencers are referred to as “free-standing circuits”.

The LSI circuit 323-1 includes a system control unit 351, a power-up unit 352, an IO unit 353, PLL control units 354-p (p=1 to n), a register setup unit 355, a power reorder unit 356, a clock gated unit 357, a power-up unit 358, and a memory IO macro unit 359.

The LSI circuit 323-1 is divided into domains, each of which is a region to which electricity is supplied from a voltage conversion element 341. The regions to which electricity is supplied from the voltage conversion elements 341-1 to 341-4 are respectively referred to as domains 1 to 4.

The system control unit 351, the power-up unit 352, and the IO unit 353 belong to the domain 1; the PLL control units 354, the register setup unit 355, the power reorder unit 356, the clock gated unit 357, and the power-up unit 358 belong to the domain 2; the memory IO macro unit 359 belongs to the domain 4.

The system control unit 351 manages the order of operations of the power-up units 352 and 358, the PLL control units 354, the register setup unit 355, the power reorder unit 356, and the clock gated unit 357, gives an instruction on the operations of these units, and monitors the operations of these units. Terminals (straps) 360-1 and 360-2 are connected to the system control unit 351. The straps 360-1 and 360-2 may be referred to as straps A and B, respectively. An external signal indicating whether or not to perform a power-on-sequence process is input to the strap 360-1. A signal indicating whether to temporarily stop the power-on-sequence process and a signal indicating whether to start the temporarily stopped process are input to the strap 360-2. The straps 360-1 and 360-2 are connected to, for example, the BMC 321 and a switch provided at the SB 320-1. Accordingly, a signal that is set by the switch and a control signal transmitted from the MMB 210 via, for example, the BMC 321 are input to the straps 360-1 and 360-2.

Meanwhile, the system control unit 351 outputs a Ready response or an interruption response to the BMC 321.

The power-up unit 352 gives a voltage adjustment instruction to the voltage conversion elements 341-2 to 341-4, and generates a reset signal. The power-up unit 352 may be referred to as a “Power Up 1”.

The IO unit 353 is an interface between the power-up unit 352 and the voltage conversion elements 341-2 to 341-4.

The PLL control units 354 control the oscillation of PLLs (not illustrated) within the LSI circuit 323-1.

The register setup unit 355 reads a signal from the strap 360-3 connected to the register setup unit 355, and gives an instruction to simultaneously set up setting registers. Note that the strap 360-3 may be referred to as a “strap C”.

The power reorder unit 356 obtains the information of the DIMM 324-1, and, when, for example, the DIMM 324-1 is operable with a voltage that is lower than an initial voltage, the power reorder unit 356 changes a power supply voltage. The power reorder unit 356 and the DIMM 324-1 are connected via a serial interface.

The clock gated unit 357 causes a clock to start to be supplied from a PLL to an element within the LSI circuit 323-1, and makes the element within the LSI circuit 323-1 operable.

The power-up unit 358 gives a voltage adjustment instruction to the voltage conversion elements 341-3 to 341-4 via the power-up unit 352, and generates a reset signal. The power-up unit 358 may be referred to as a “Power Up 2”.

The memory IO macro unit 359 is an interface that transmits data to and receives data from the DIMM 324-1.

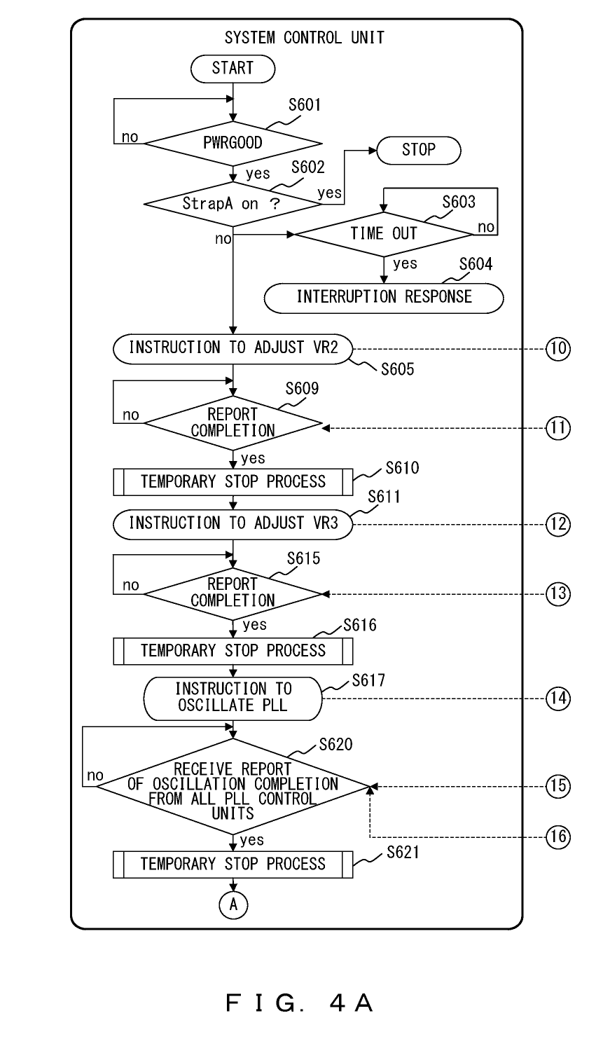

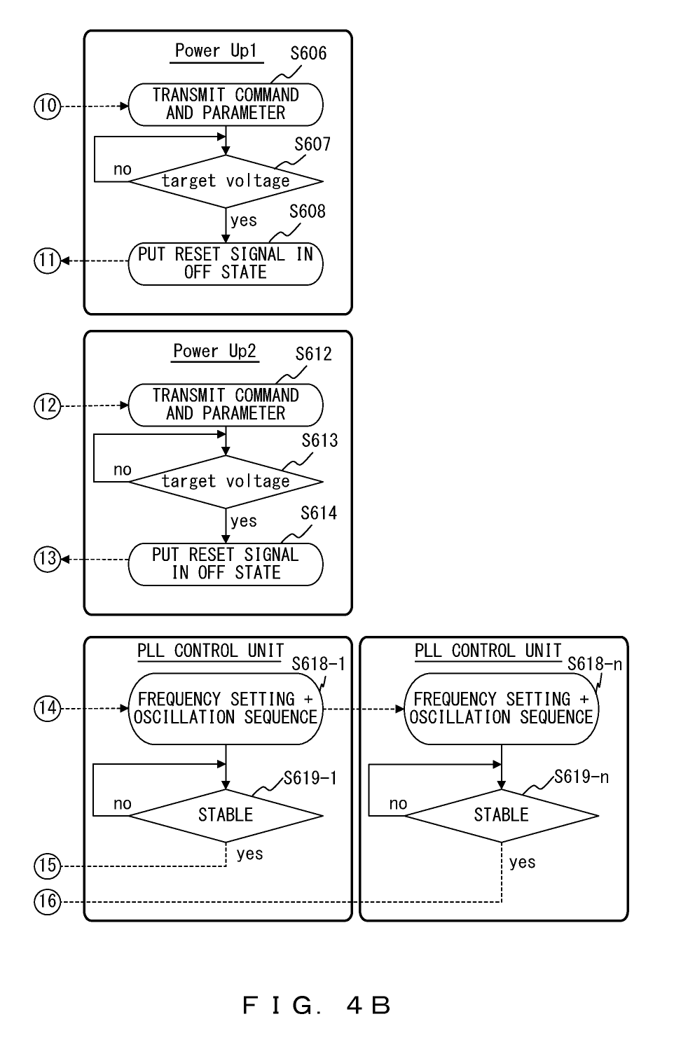

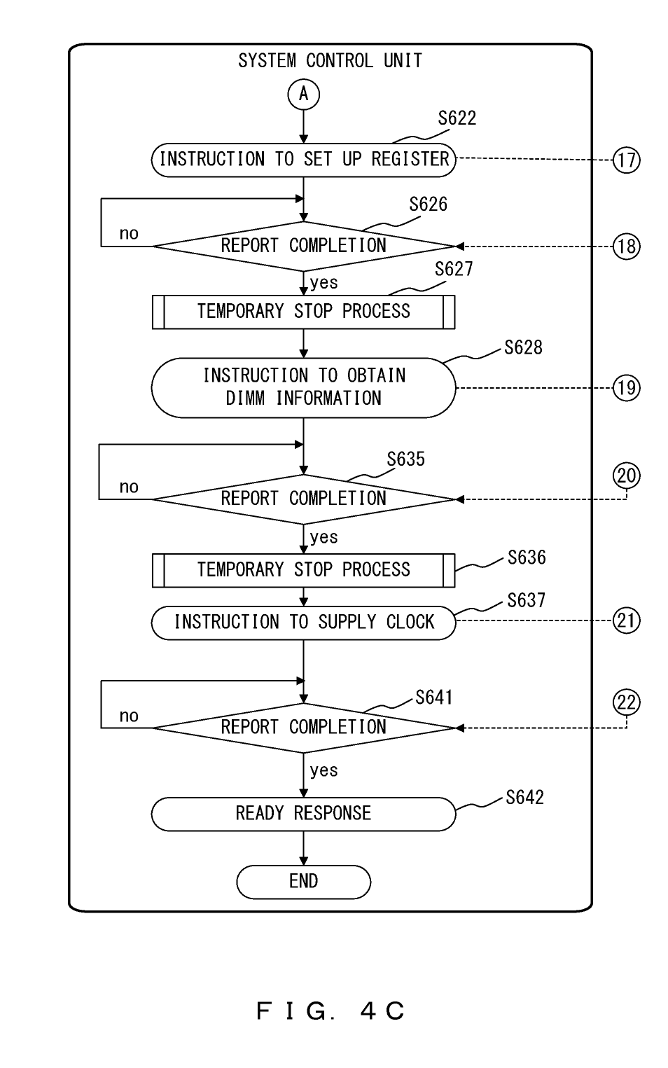

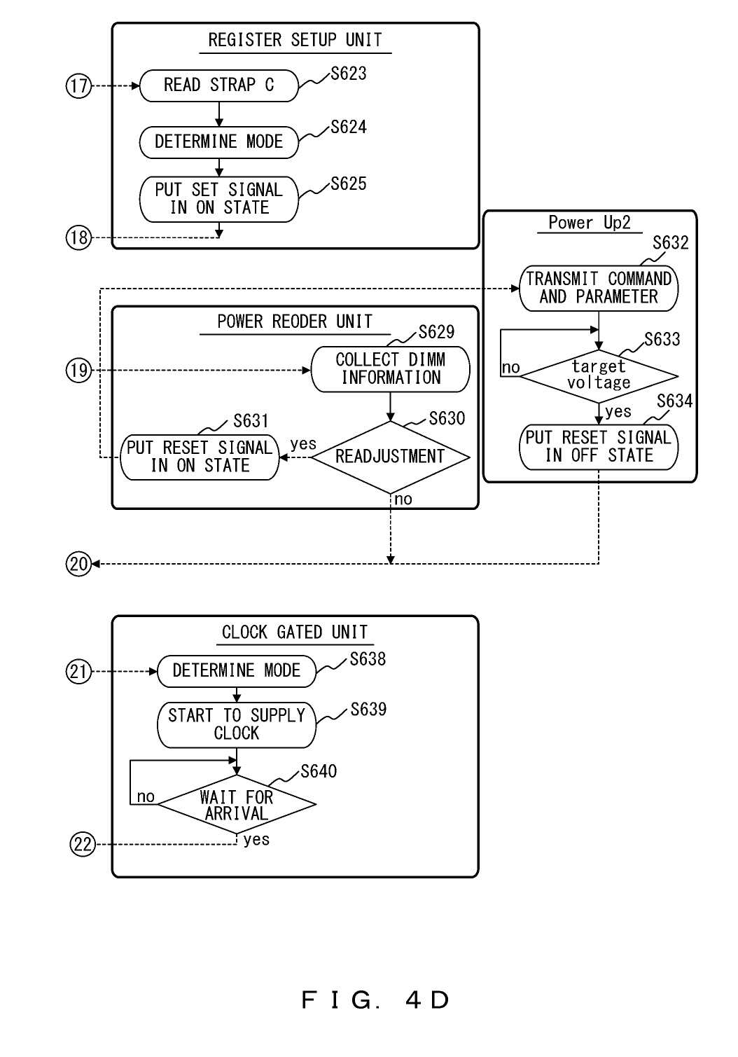

FIGS. 4A to 4D illustrate a power-on sequence of an LSI circuit in accordance with an embodiment.

In step S601, the system control unit 351 determines whether or not a PWRGOOD signal has been input from the BMC 321. When it is determined that the PWRGOOD signal has been input, the control shifts to step S602.

In step S602, the system control unit 351 determines whether or not a signal of the strap A is in an ON state (i.e., whether or not to perform the power-on-sequence process via external control). When the signal of the strap A is in the ON state, the process is stopped to execute the power-on sequence via external control; when the signal of the strap A is in an OFF state, the control shifts to steps S603 and S605, and the power-on sequence by the sequencers within the LSI circuit 323-1 continues.

Using a signal of an external terminal (strap), the LSI circuit 323-1 in accordance with an embodiment may inhibit a power-on-sequence operation by the sequencers within the LSI circuit 323-1. Such a function, which is called a free-standing-circuit inhibiting function, is used to, for example, externally control the power-on sequence.

The processes of steps S603 to S604 are performed independently from the processes of steps S605 to S639.

In step S603, the system control unit 351 activates a timer and determines whether the timer has expired. The timer expires when a predetermined time period has elapsed. When the timer has expired (i.e., after a time out), the control shifts to step S604; when the timer has not expired, the operation of S603 continues.

In step S604, the system control unit 351 outputs an interruption response to the BMC 321.

As indicated by the processes of steps S603 to S604, an interruption response is output to the BMC 321 when the power-on sequence is not completed in a predetermined time period.

In step S605, the system control unit 351 outputs to the power-up unit 352 an instruction to adjust the voltage of the voltage conversion element 341-2 (VR2).

In step S606, the power-up unit 352 transmits to the voltage conversion element 341-2 a command and a parameter to make an adjustment to achieve a specified voltage (a target voltage). Using the received command and the received parameter, the voltage conversion element 341-2 adjusts and changes the output voltage to the specified voltage. The voltage conversion element 341-2 writes the value of the output voltage in a register installed in the voltage conversion element 341-2.

In step S607, the power-up unit 352 polls the register installed in the voltage conversion element 341-2 and checks the output voltage stored in the register. When the output voltage is equal to the specified voltage (i.e., when the voltage adjustment has been completed), the control shifts to step S608.

In step S608, the power-up unit 352 puts, in the OFF state, a reset signal (reset2) to the elements of the domain 2 of the LSI circuit 323-1 (i.e., the region operated by the electricity from the voltage conversion element 341-2) . Then, the power-up unit 352 reports an adjustment completion to the system control unit 351.

In step S609, when the system control unit 351 receives the report of the completion of the adjustment made by the power-up unit 352, the control shifts to step S610.

In step S610, the system control unit 351 performs a temporary stop process via the strap B in accordance with the situation. The temporary stop process will be described hereinafter.

In step S611, the system control unit 351 outputs to the power-up unit 358 an instruction to adjust the voltage of the voltage conversion element 341-3 (VR3).

In step S612, the power-up unit 358 transmits, via the power-up unit 352 and to the voltage conversion element 341-3, a command and a parameter to make an adjustment to achieve a specified voltage. Using the received command and the received parameter, the voltage conversion element 341-3 adjusts and changes the output voltage to the specified voltage. The voltage conversion element 341-3 writes the value of the output voltage in a register installed in the voltage conversion element 341-3.

In step S613, the power-up unit 358 polls the register installed in the voltage conversion element 341-3 and checks the output voltage stored in the register. When the output voltage is equal to the specified voltage (i.e., when the voltage adjustment has been completed), the control shifts to step S614.

In step S614, the power-up unit 358 puts, in the OFF state, a reset signal (reset3) to the elements of the domain 3 of the LSI circuit 323-1 (i.e., the region operated by the electricity from the voltage conversion element 341-3) . Then, the power-up unit 358 reports an adjustment completion to the system control unit 351.

In step S615, when the system control unit 351 receives the report of the completion of the adjustment, the control shifts to step S616.

In step S616, the system control unit 351 performs a temporary stop process via the strap B in accordance with the situation.

In step S617, the system control unit 351 instructs the PLL control units 354-p to oscillate.

In step S618-p, the PLL control unit 354-p sets a frequency for a PLL (not illustrated) connected to the PLL control unit 354-p and executes a predetermined oscillation sequence.

In step S619-p, when the PLL is stabilized, the PLL control unit 354-p reports an oscillation completion to the system control unit 351.

In step S620, when the system control unit 351 receives the report of the oscillation completion from all of the PLL control units 354-p, the control shifts to step S621.

In step S621, the system control unit 351 may perform a temporary stop process via the strap B.

In step S622, the system control unit 351 instructs the register setup unit 355 to set up a register.

In step S623, the register setup unit 355 obtains information from the strap C.

In step S624, according to the obtained information, the register setup unit 355 determines an operation mode (e.g., high speed, medium speed, or low speed) of the LSI circuit 323-1.

In step S625, the register setup unit 355 transmits to a register within the LSI circuit 323-1 a setting pulse that sets the value of the register to the determined mode. The register setup unit 355 reports a register-setup completion to the system control unit 351.

In step S626, when the system control unit 351 receives the report of the register-setup completion, the control shifts to step S627.

In step S627, the system control unit 351 may perform a temporary stop process via the strap B.

In step S628, the system control unit 351 instructs the power reorder unit 356 to obtain information of the DIMM 324-1.

In step S629, the power reorder unit 356 obtains from the DIMM 324-1 the information indicating an operating voltage of the DIMM 324-1.

In step S630, according to the obtained information of the operating voltage, the power reorder unit 356 determines whether or not the voltage of the DIMM 324-1 needs to be readjusted. When the readjustment needs to be made, e.g., when the operating voltage of the DIMM 324-1 is lower than the currently output voltage (the initial voltage) of the VR4, the control shifts to step S531; when the readjustment does not need to be made, the power reorder unit 356 reports a DIMM adjustment completion to the system control unit 351.

In step S631, the power reorder unit 356 puts a reset signal to the memory IO macro unit 359 and the DIMM 324-1 in the ON state. The power reorder unit 356 also instructs the power-up unit 358 to adjust the voltage of the voltage conversion element 341-4. Moreover, the power reorder unit 356 transmits the obtained information of the operating voltage to the power-up unit 358.

In step S632, the power-up unit 358 transmits, via the power-up unit 352 to the voltage conversion element 341-4, a command and a parameter to make adjustments to achieve the operating voltage of the DIMM 324-1 . Using the received command and the received parameter, the voltage conversion element 341-4 adjusts and changes the output voltage to the operating voltage. The voltage conversion element 341-4 writes the value of the output voltage in a register installed in the voltage conversion element 341-4.

In step S633, the power-up unit 358 polls the register installed in the voltage conversion element 341-4 and checks the output voltage stored in the register. When the output voltage is equal to the operating voltage (i.e., when the voltage adjustment has been completed) , the control shifts to step S634.

In step S634, the power-up unit 358 puts a reset signal to the DIMM 324-1 in the OFF state. Then, the power-up unit 358 reports a DIMM adjustment completion to the system control unit 351.

In step S635, when the system control unit 351 receives the DIMM adjustment completion, the control shifts to step S636.

In step S636, the system control unit 351 may perform a temporary stop process via the strap B.

In step S637, the system control unit 351 instructs the clock gated unit 357 to perform clock supplying.

In step S638, the clock gated unit 357 determines the operation mode of the LSI circuit 323-1 according to the information obtained in step S623.

In step S639, the clock gated unit 357 starts the supplying of a clock from a PLL to the elements within the LSI circuit 323-1 that correspond to the determined operation mode. That is, in accordance with an operation mode, the supplying of a clock to a circuit that is not in use or to a high-speed interface is suppressed.

In step S640, the clock gated unit 357 waits for the clock to reach the elements, and, after passage of a predetermined time period, the clock gated unit 357 reports to the system control unit 351 the completion of clock supplying.

In step S641, when the system control unit 351 receives the report of the completion of clock supplying, the control shifts to step S642.

In step S642, the system control unit 351 outputs a Ready response indicating a preparation completion to the BMC 321. The system control unit 351 also stops the process of step S603, i.e., stops the timer, so as to prevent an interruption response from being output.

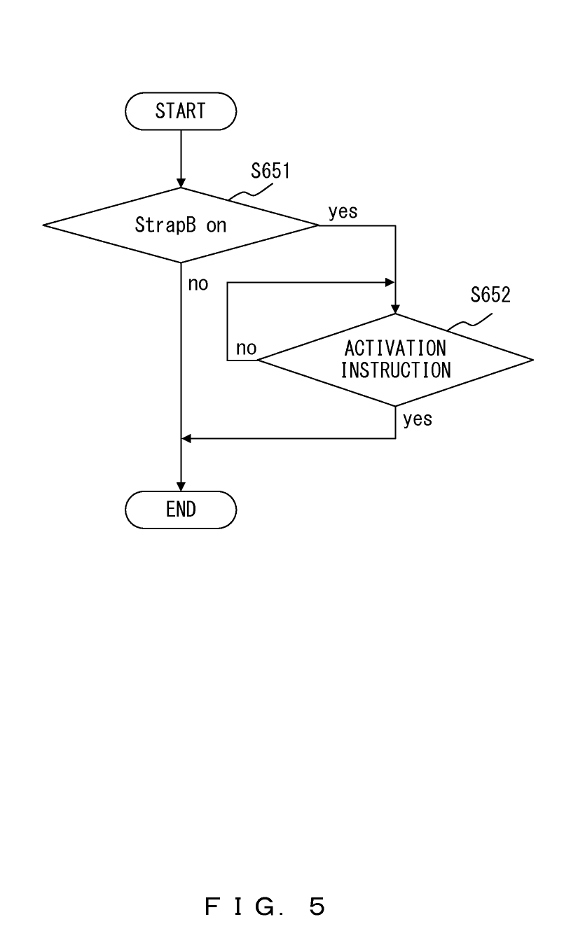

FIG. 5 is a flowchart of details of a temporary stop process.

The processes illustrated in FIG. 5 correspond to the processes of steps S610, S616, S621, S627, and S636 in FIGS. 4A to 4D.

In step S651, the system control unit 351 determines which of the ON state and the OFF state a signal from the strap B is in. When the signal of the strap B is in the ON state, the control shifts to step S652; when the signal of the strap B is in the OFF state, a temporary stop process is not performed.

In step S652, the system control unit 351 determines whether or not an activation instruction has been given by the strap B, and, when the activation instruction has been given, the system control unit 351 ends the temporary stop process. Meanwhile, when the activation instruction has not been given, the control returns to step S652, i.e., the system control unit 351 waits until the strap B gives the activation instruction.

Using the temporary stop process allows the servers to establish the synchronism between the sequences. With the temporary stop process, a temporary stop may be made in response to the report of completion of each sequence, thereby enabling the status to be checked and investigated at the moment when a problem occurs.

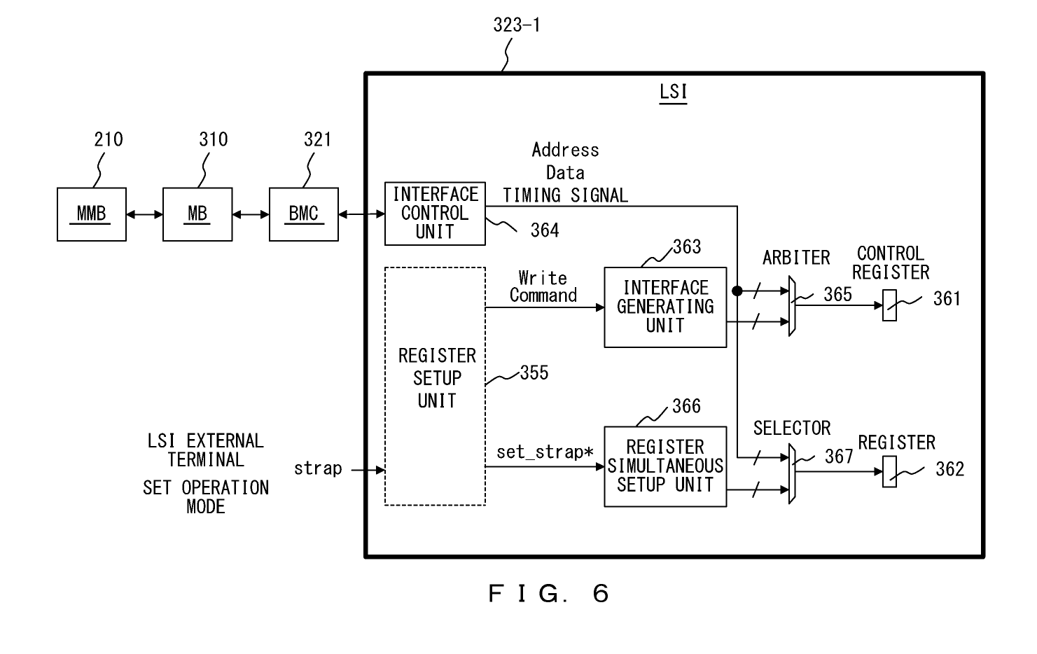

FIG. 6 illustrates a configuration related to register setups of an LSI circuit in accordance with an embodiment.

Here, descriptions will be given of the setting of values for a control register 361 and a register 362 within the LSI circuit 323-1.

The configuration and the operation described below allow the LSI circuit 323-1 to set the values of the control register 361 and the register 362 via both an external element (the MMB 210) and an internal element (the register setup unit 355).

The LSI circuit 323-1 further includes the control register 361, the register 362, an interface generating unit 363, an interface control unit 364, an arbiter 365, a register simultaneous setup unit 366, and a selector 367.

To set values for the control register 361 and the register 362, the MMB 210 outputs a control signal to the interface control unit 364 via the MB 310 and the BMC 321.

In response to the control signal from the MMB 210, the interface control unit 364 generates an address data signal, a write data signal, and a timing data (write enable (WE)) signal, all of which are to be used to write data to the control register 361, and the interface control unit 364 outputs these signals to the arbiter 365.

The control register 361 is a register that needs to be set up in accordance with a predetermined setup procedure.

The register 362 is a register that does not need to be set up in accordance with a predetermined setup procedure.

Data is written to the control register 361 as follows.

The register setup unit 355 generates and outputs a write command to the interface generating unit 363. The interface generating unit 363 generates from the write command an address data signal, a write data signal, and a timing data (write enable (WE)) signal, and outputs these signals to the arbiter 365. The signals generated by the interface generating unit 363 are in a form similar to the form of the signals generated by the interface control unit 364.

The arbiter 365 arbitrates between the two paths, a path 1 for accessing from the interface control unit 364 to the control register 361 and a path 2 from the interface generating unit 363 to the control register 361, and the arbiter 365 accesses the control register 361. The arbiter 365 selects a path by referencing the register that stores the information indicating which of an external element and an internal element is to be used to set up the control register 361.

As described above, the LSI circuit 323-1 may set up the control register 361 via both an element external to the LSI circuit 323-1 (the MMB 210) and an element within the LSI circuit 323-1 (the register setup unit 355).

Data is written to the register 362 as follows.

The register setup unit 355 reads the strap 360-3, determines a mode according to the information from the strap 360-3, and outputs to the register simultaneous setup unit 366 a strap signal (set_strap*) that corresponds to the determined mode.

The register simultaneous setup unit 366 outputs the strap signal to a selector 367. In this case, when there are a plurality of registers, the register simultaneous setup unit 366 transmits the strap signal set_strap* simultaneously to a plurality of selectors each connected to each register.

Meanwhile, the interface control unit 364 outputs an address data signal, a write data signal, and timing data to the selector 367.

The selector 367 selects and outputs to the register 362 any of the signals from the interface control unit 364 or from the register simultaneous setup unit 366.

The register 362 is set to the value of the signal input from the selector 367.

When there are a plurality of registers that do not need to be set up in accordance with the predetermined setup procedure, a signal is transmitted simultaneously to these registers (to selectors connected to these registers, in particular), so that these plurality of registers can be simultaneously set up.

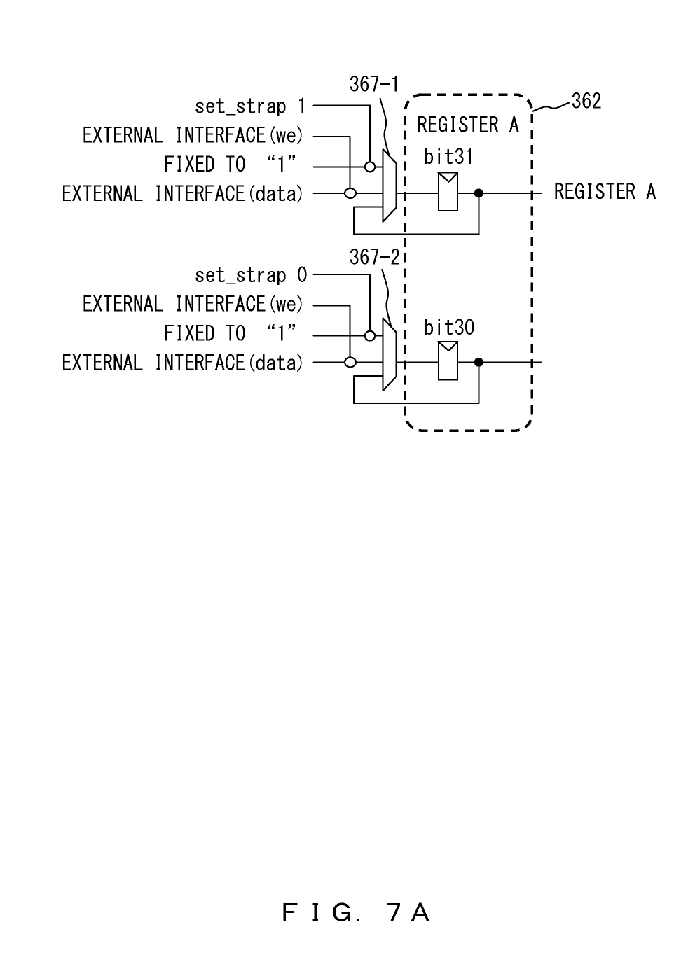

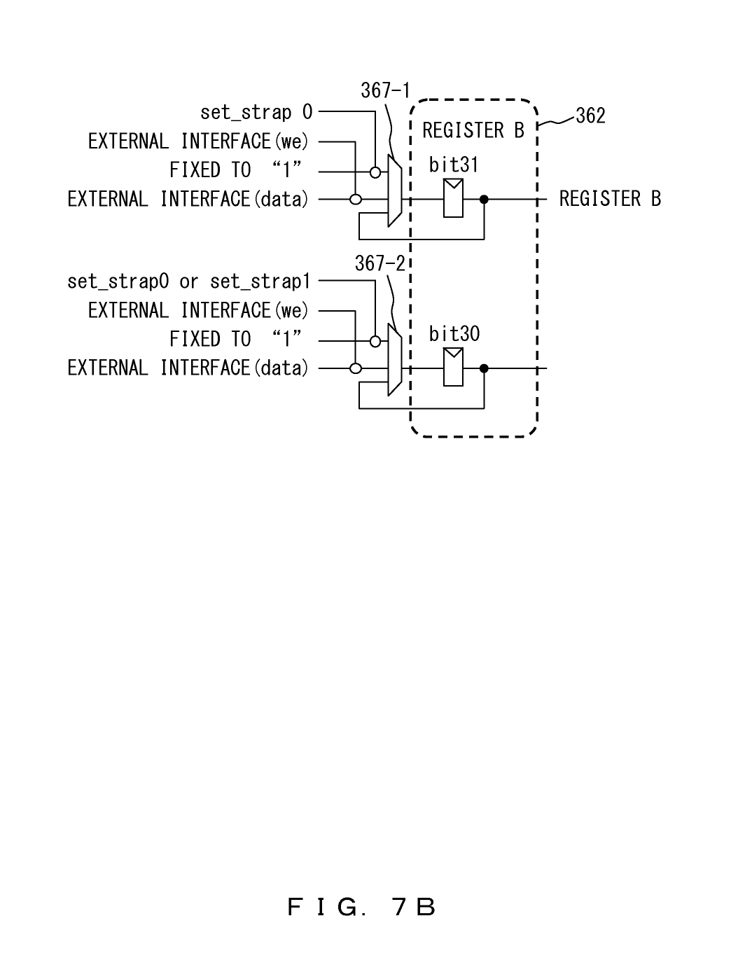

FIG. 7A and FIG. 7B illustrate data writing to a register in accordance with an embodiment.

With reference to FIG. 7A, descriptions will be given of data writing to a bit 30 and a bit 31 of a register A, i.e., the register 362.

The selector 367-1 connected to the bit 31 of the register A has input thereto: the logical product of a signal fixed to a value of “1” and a strap signal set_strap1 from the register setup unit 355; and the logical product of a write data signal (data) and timing data (we) from the interface control unit 364 (an external interface).

The selector 367-2 connected to the bit 30 of the register A has input thereto: the logical product of a signal fixed to a value of “1” and a strap signal set_strap0 from the register setup unit 355; and the logical product of a write data signal (data) and timing data (we) from the interface control unit 364 that is an external interface.

Here, descriptions will be given of setting up the registers by the register setup unit 355, so such descriptions are based on the assumption that a signal is not output from the interface control unit 364.

In such a configuration, the bit 30 and the bit 31 of the register A are set up as follows in accordance with the strap signals.

When the strap signal set_strap0 indicates 1, 1 is input to the selector 367-2, so the value of the bit 30 is 1. When the strap signal set_strap0 indicates 0, 0 is input to the selector 367-2, so the value of the bit 30 is 0.

When the strap signal set_strap1 indicates 1, 1 is input to the selector 367-1, so the value of the bit 31 is 1. When the strap signal set_strap1 indicates 0, 0 is input to the selector 367-1, so the value of the bit 31 is 1.

With reference to FIG. 7B, descriptions will be given of data writing to a bit 30 and a bit 31 of a register B, i.e., the register 362.

The selector 367-1 connected to the bit 31 of the register B has input thereto: the logical product of a signal fixed to a value of “1” and a strap signal set_strap0; and the logical product of a write data signal (data) and timing data (we) from the interface control unit 364 (an external interface).

The selector 367-2 connected to the bit 30 of the register B has input thereto: the logical product of a signal fixed to a value of “1” and the strap signal set_strap0 or a strap signal set_strap1; and the logical product of a write data signal (data) and timing data (we) from the interface control unit 364 that is an external interface.

Here, descriptions will be given of setting up the registers by the register setup unit 355, so such descriptions are based on the assumption that a signal is not output from the interface control unit 364.

In such a configuration, the bit 30 and the bit 31 of the register B are set up as follows in accordance with the strap signals.

When the strap signal set_strap0 indicates 1 and the strap signal set_strap1 indicates 1, 1 is input to the selectors 367-1 and 367-2, and the values of the bit 30 and the bit 31 are 1.

When the strap signal set_strap0 indicates 0 and the strap signal set_strap1 indicates 1, 0 is input to the selector 367-1, the value of the bit 31 is 0, 1 is input to the selector 367-2, and the value of the bit 30 is 1.

When the strap signal set_strap0 indicates 1 and the strap signal set_strap1 indicates 0, 1 is input to the selector 367-1, the value of the bit 31 is 1, 1 is input to the selector 367-2, and the value of the bit 30 is 1.

When the strap signal set_strap0 indicates 0 and the strap signal set_strap1 indicates 0, 0 is input to the selectors 367-1 and 367-2, and the values of the bit 31 and the bit 30 are 0.

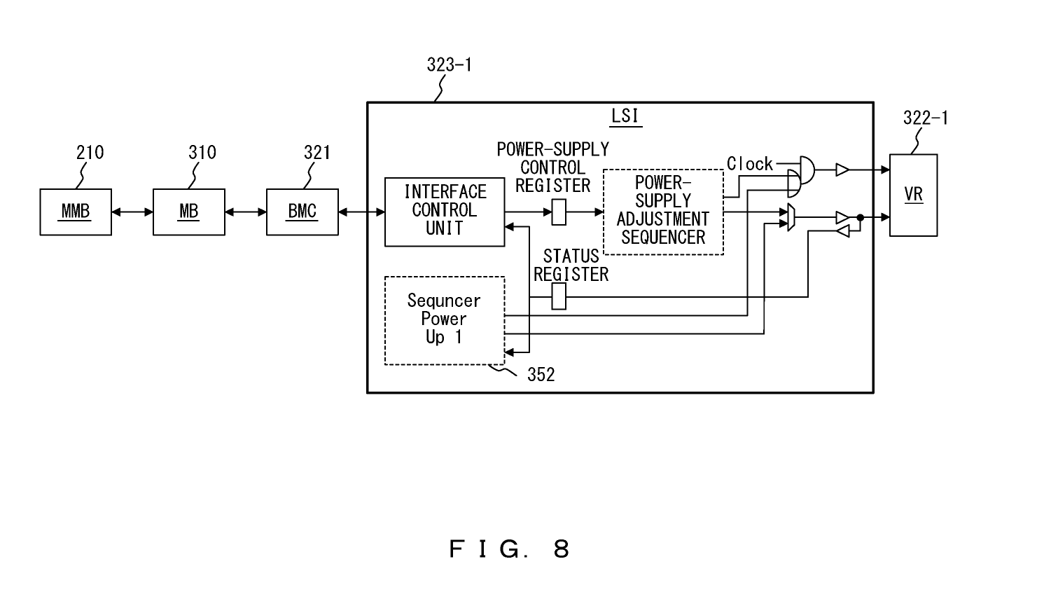

FIG. 8 illustrates a configuration related to adjustment of a power-supply circuit of an LSI circuit in accordance with an embodiment.

In the apparatus of the embodiment, the LSI circuit 323 adjusts the power-supply circuit 322; accordingly, the power-supply circuit 322 is connected to the LSI circuit 323 via a dedicated interface, and the power-supply circuit 322 is not directly connected to the BMC 321.

Thus, to adjust the power-supply circuit 322 via an external element such as the MMB 210, the embodiment allows the power-supply circuit to be adjusted via the external LSI circuit, as will be described hereinafter.

In the controlling of a power-on sequence via an external element or in the performing of a heavy-load test in a pre-shipment test, the power-supply circuit 322 is adjusted using the components described hereinafter in order to adjust and change a specified voltage to a high voltage or a low voltage.

The LSI circuit 323-1 further includes an interface control unit 371, a power-supply control register 372, a status register 373, a power-supply adjustment sequencer 374, an OR circuit 375, an AND circuit 376, and a selector 377.

Using an external interface, the MMB 210 writes a voltage-adjustment command (including a voltage parameter) to the power-supply control register 372 within the LSI circuit 323-1 via the MB 310, the BMC 321, and the interface control unit 371. The interface control unit 371 writes data to and reads data from the power-supply control register 372 and the status register 373.

The power-supply adjustment sequencer 374 is operated when a voltage adjustment command for adjustment to a target voltage is written to the power-supply control register 372 within the LSI circuit 323-1 by the MMB 210. The power-supply adjustment sequencer 374 transmits the voltage adjustment command to the power-supply circuit 322-1 for which a voltage is to be adjusted.

In particular, the power-supply adjustment sequencer 374 transmits the voltage adjustment command to the selector 377. The selector 377 selects and outputs to the power-supply circuit 322-1 the voltage adjustment command from the power-supply adjustment sequencer 374 or the voltage adjustment command from the power-up unit 352. When a voltage adjustment command has been written to the power-supply control register 372 (i.e., when the power-supply circuit 322-1 has been controlled by an external element), the selector 377 selects and outputs the voltage adjustment command from the power-supply adjustment sequencer 374.

In addition, the power-supply adjustment sequencer 374 transmits a clock-supplying start instruction to the OR circuit 375. Upon receipt of a clock-supplying start instruction from the power-supply adjustment sequencer 374 or the power-up unit 352, the OR circuit 375 transmits the clock-supplying start instruction to the AND circuit 376. Upon receipt of the clock-supplying start instruction, the AND circuit 376 outputs a clock to the power-supply circuit 322-1.

Upon receipt of a voltage adjustment command from the LSI circuit 323-1, the power-supply circuit 322-1 adjusts a voltage.

To perform monitoring to determine whether the adjustment of the power-supply circuit 322-1 has been completed, the MMB 210 uses an external interface so as to write a status command of the power-supply circuit 322-1 to the power-supply control register 372 within the LSI circuit 323-1 via the interface control unit 371.

When a status command is written to the power-supply control register 372 within the LSI circuit 323-1, the power-supply adjustment sequencer 374 is operated to transmit the status command to the power-supply circuit 322-1 for which a voltage is to be adjusted.

Upon receipt of the status command, the power-supply circuit 322-1 responsively reports the status of the inside of the power-supply circuit 322-1. The status is, for example, the value of an output voltage of the power-supply circuit 322-1.

The LSI circuit 323-1 stores the status received from the power-supply circuit in the status register 373.

The MMB 210 may obtain and check the status stored in the status register 373, thereby recognizing that the adjustment of the power-supply circuit 322-1 to achieve a target voltage has been completed. That is, the completion of the adjustment may be recognized by confirming whether or not the value of the output voltage of the power-supply circuit 322-1 stored in the status register 373 is equal to the target voltage .

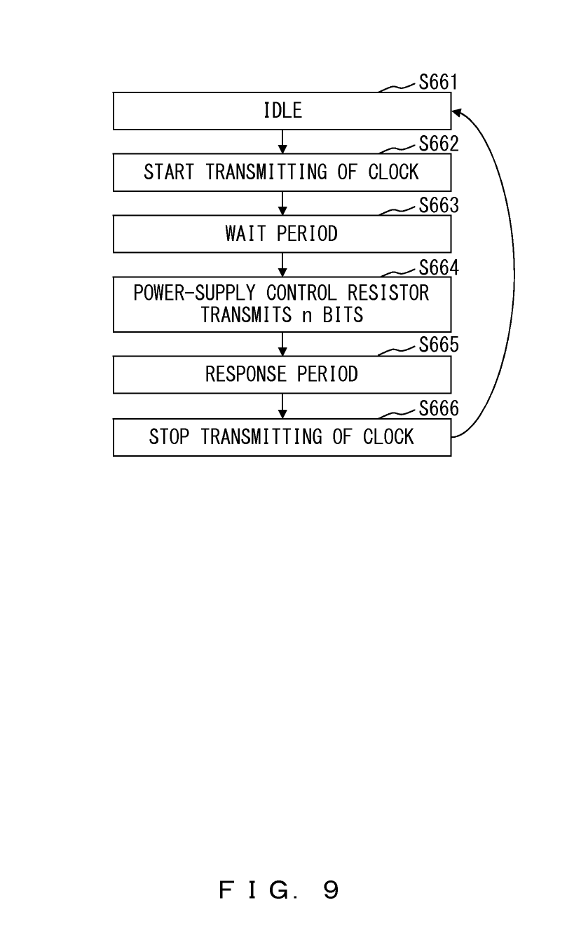

FIG. 9 is a flowchart of a process performed by a power-supply adjustment sequencer in accordance with an embodiment.

The power-supply adjustment sequencer 374 is initially in an idle state (step S611), and, when a voltage adjustment command for adjustment to a target voltage is written to the power-supply control register 372, the power-supply adjustment sequencer 374 transmits a clock-supplying start instruction to the OR circuit 375 (step S662).

When a wait period has elapsed (S663), the power-supply adjustment sequencer 374 transmits n bits of content of the power-supply control register 372 to the selector 377 (S664).

When a predetermined response period has elapsed after the transmission of the content of the power-supply control register 372 (step S665), the power-supply adjustment sequencer 374 stops the transmitting of a clock-supplying start instruction (step S666) . Then, the control returns to step S661.

In a system in accordance with an embodiment, a plurality of servers execute in parallel a power-on sequence that includes, for example, the adjusting of a voltage and the setting up of a register, so that the period of the power-on sequence of the system can be shortened.

That is, the system management apparatus does not need to execute a power-on sequence for each server, thereby achieving the advantage that the period of the power-on sequence of the system makes little change even when the number of servers increases.

Register settings and register setup procedures may vary according to the version of an LSI circuit. LSI circuits with different functions have different kinds of registers, different register settings, and different register setup procedures. A change in the technology may lead to a different power-supply voltage of the LSI circuit.

Accordingly, in LSI-circuit replacing in the conventional system, an MMB needs to identify the type and the version of an LSI circuit, and software of the MMB needs to be patched and addressed in accordance with the changed version. Thus, the conventional system has had a problem of taking time and effort associated with LSI-circuit replacing.

Dual inline memory modules (DIMMs) have a power-supply voltage that varies according to their type.

Accordingly, in DIMM replacing in the conventional system, an MMB needs to identify the type of a DIMM, and software of the MMB needs to be patched and addressed in accordance with the changed version. Thus, the conventional system has had a problem of taking time and effort associated with DIMM replacing.

In the system in accordance with the embodiment, even when the server configuration is changed due to LSI-circuit replacing or DIMM replacing, the MMB does not need to be patched or addressed in accordance with the version, thereby saving time and effort.

In accordance with the embodiment, the number of servers, SBs, or LSI circuits is not limited to those described above, so any number of servers, SBs, or LSI circuits may be used.

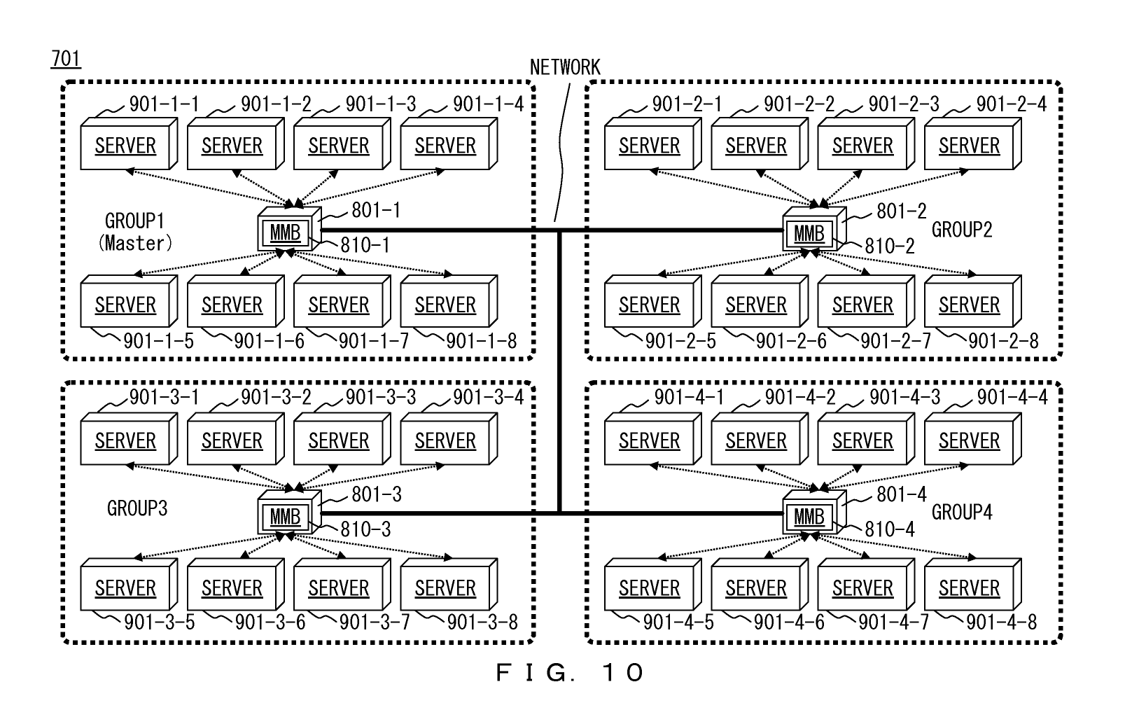

FIG. 10 is a configuration diagram of a system in accordance with another embodiment.

With reference to this other embodiment, in regard to a very-large-scale system with many servers, descriptions will be given of a power-on sequence for which a plurality of system management apparatuses are used.

A system 701 includes system management apparatuses 801-q (q=1 to 4) and servers 901-q-r (r=1 to 8).

The server 901-q-r is connected to the system management apparatus 801-q via a serial interface.

The system management apparatuses 801-q are connected to each other via a network (e.g., a Local Area Network). The system management apparatus 801-1 is also referred to as a master herein. The system management apparatus 801-q includes an MMB 810-q. The configuration of the MMB 810-q is similar to that of the MMB 210 of the aforementioned embodiment, except for the fact that the MMB 810-q is connected to the other MMBs.

The system management apparatus 801-1 outputs a power-on instruction to the server 901-1-r and the system management apparatus 801-s (s=2 to 4).

Upon receipt of the power-on instruction, the system management apparatuses 801-2 to 801-4 respectively output the power-on instruction to the servers 901-2-r to 901-4-r.

The apparatuses within the system 701 are divided into groups, and the system management apparatus 801-q and the server 901-q-r belong to a group q.

The server 901 has a configuration similar to that of the server 301 of the aforementioned embodiment, and, upon receipt of a power-on instruction, the server 901 executes a power-on sequence similar to that of the aforementioned embodiment.

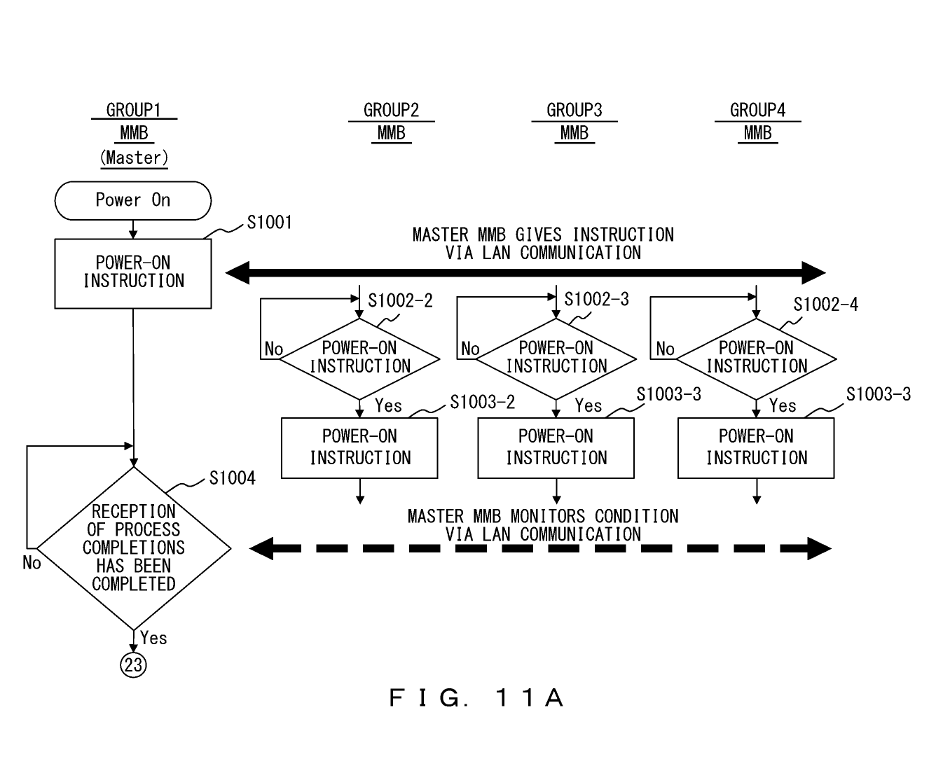

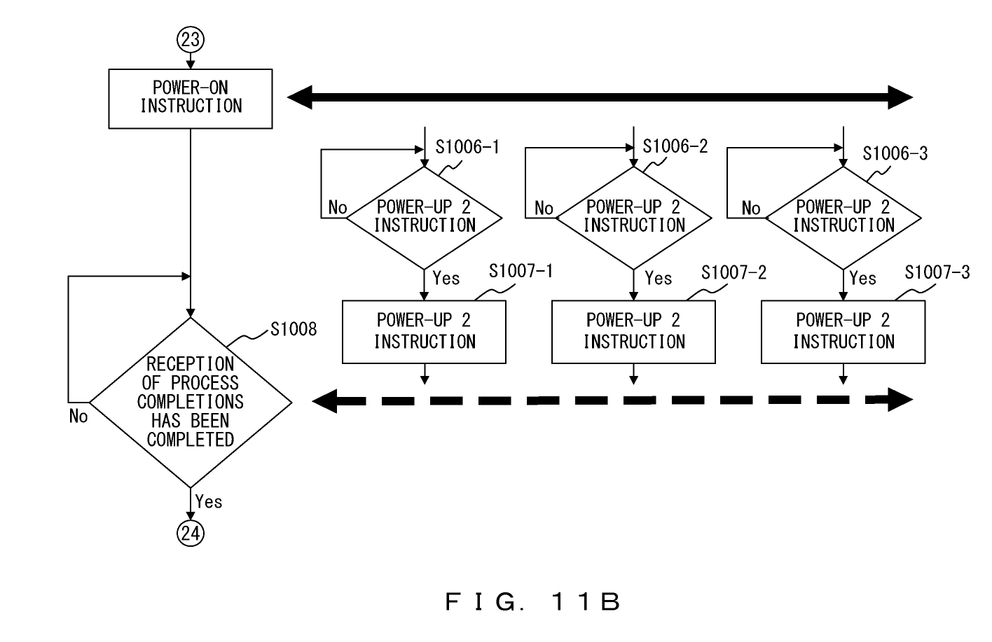

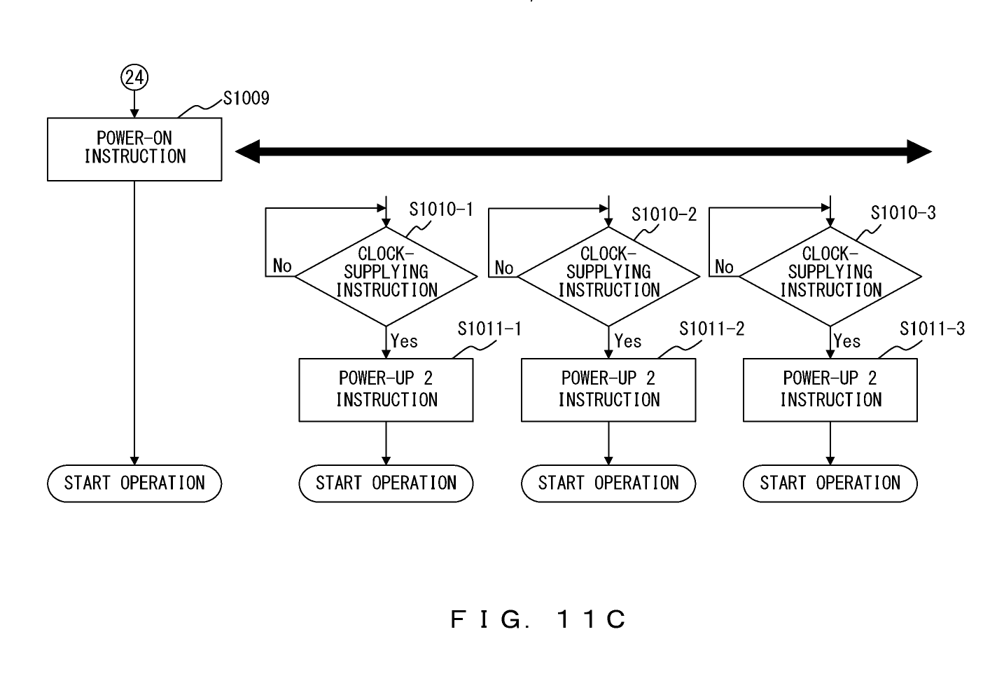

FIGS. 11A to 11C illustrate a power-on sequence of a system in accordance with another embodiment.

In step S1001, the MMB 810-1 outputs a power-on instruction to the server 901-1-r and the system management apparatuses 801-2 to 801-4.

The server 901-1-r performs the processes of steps S601 to 5610, and waits for an activation instruction in step S652. The server 901-1-r reports a process completion to the MMB 810-1.

When the MMB 810-s receives the power-on instruction in step S1002-s, the control shifts to step S1003-s.

In step S1003-s, the MMB 810-s transmits a power-on (activation) instruction to the server 901-s-r.

The server 901-s-r performs the processes of steps S601 to S610, and waits for an activation instruction in step S652. The server 901-s-r reports a process completion to the MMB 810-s.

Upon receipt of the process completion from the server 901-s-r, the MMB 810-s reports the process completion to the MMB 810-1.

When the MMB 810-1 receives the process completions from the server 901-1-r and the MMB 810-1 in step 51004, the control shifts to step S1005.

In step S1005, the MMB 810-1 outputs a power-on instruction to the server 901-1-r and the system management apparatuses 801-2 to 801-4.

The server 901-1-r performs the processes of steps S611 to S636, and waits for an activation instruction in step S652. The server 901-1-r reports a process completion to the MMB 810-1.

When the MMB 810-s receives the power-on instruction in step S1006-s, the control shifts to step S1007-s.

In step S1007-s, the MMB 810-s transmits a power-on instruction to the server 901-s-r.

The server 901-s-r performs the processes of steps S611 to S636, and waits for an activation instruction in step S652. The server 901-s-r reports a process completion to the MMB 810-s.

When the MMB 810-1 receives the process completions from the server 901-1-r and the MMB 810-1 in step S1008, the control shifts to step S1005.

In step S1009, the MMB 810-1 outputs a power-on instruction to the server 901-1-r and the system management apparatuses 801-2 to 801-4.

The server 901-1-r performs the processes of steps S637 to S642. Upon receipt of a Ready response from the server 901-1-r, the MMB 810-1 starts to operate the server 901-1-r.

When the MMB 810-s receives the power-on instruction in step S1010-s, the control shifts to step S1011-s.

In step S1011-s, the MMB 810-s transmits a power-on instruction to the server 901-s-r.

The server 901-s-r performs the processes of steps S637 to S642.

Upon receipt of a Ready response from the server 901-2-r, the MMB 810-2 starts to operate the server 901-2-r.

In accordance with the system of this other embodiment, the system management apparatus 801 is connected to the network, and the temporary stop process is used to establish the synchronism between the power-on sequences of the groups, with the result that the variation in power-on sequence time between the groups can be decreased.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses including a system board provided with an integrated circuit and a power-supply circuit that supplies electricity to the integrated circuit; and
a system management apparatus configured to transmit a power-on instruction to the plurality of information processing apparatuses, wherein
the integrated circuits of the plurality of information processing apparatuses each include a plurality of power-supply domains, and, upon receipt of the power-on instruction, the integrated circuits instruct the power-supply circuit to adjust a voltage and supply electricity sequentially to the plurality of power-supply domains.

2. The information processing system according to claim 1, wherein
the system board further includes a memory,
the power-supply circuit supplies electricity to the memory, and
upon receipt of the power-on instruction, the integrated circuit obtains information of the memory, and, according to the information, the integrated circuit instructs the power-supply circuit to adjust a voltage supplied to the memory.

3. The information processing system according to claim 1, wherein
upon receipt of the power-on instruction, the integrated circuit sets up a register within the integrated circuit.

4. The information processing system according to claim 1, wherein
the integrated circuit includes
a phase synchronization circuit configured to output a synchronization signal to an element within the integrated circuit, and
a phase-synchronization-circuit controlling unit configured to control the phase synchronization circuit, wherein
upon receipt of the power-on instruction, the integrated circuit causes the phase-synchronization-circuit controlling unit to control oscillation of the phase synchronization circuit.

5. The information processing system according to claim 1, wherein
the integrated circuit makes an error report to the system management apparatus when a predetermined time period elapses after the integrated circuit has received the power-on instruction.

6. A system management apparatus connected to a plurality of information processing apparatuses provided with an integrated circuit that includes a plurality of power-supply domains, the system management apparatus comprising:
a processor, wherein
the processor
transmits a power-on instruction to the plurality of information processing apparatuses,
upon receipt of a response indicating an activation completion from the plurality of information processing apparatuses, starts to operate the plurality of information processing apparatuses, and
when an error report transmitted from any of the plurality of information processing apparatuses has been received or a predetermined time period elapses after the power-on instruction has been transmitted, inquires about an error cause with the information processing apparatus that has transmitted the error report or with the information processing apparatus that has not transmitted the response indicating the activation completion.

7. An integrated circuit provided at a system board included in an information processing apparatus, the integrated circuit comprising:
a plurality of power-supply domains, wherein
upon receipt of a power-on instruction from an external apparatus connected to the information processing apparatus, the integrated circuit gives an instruction to adjust a voltage to a power-supply circuit that supplies electricity to the integrated circuit, and supplies electricity sequentially to the plurality of power-supply domains.

8. The integrated circuit according to claim 7, wherein
upon receipt of the power-on instruction, the integrated circuit obtains information of a memory provided at the system board, and, according to the information, the integrated circuit instructs the power-supply circuit to adjust a voltage supplied to the memory.

9. The integrated circuit according to claim 7, wherein
upon receipt of the power-on instruction, the integrated circuit sets up a register within the integrated circuit.

10. The integrated circuit according to claim 7, further comprising:
a phase synchronization circuit configured to output a synchronization signal to an element within the integrated circuit; and
a phase-synchronization-circuit controlling unit configured to control the phase synchronization circuit, wherein
upon receipt of the power-on instruction, the integrated circuit causes the phase-synchronization-circuit controlling unit to control oscillation of the phase synchronization circuit.
